(19) United States
(12) Patent Application Publication
(10) Pub. No.: US 2018/0045853 A1
(43) Pub. Date: Feb. 15, 2018

(54) LANDSLIDE HAZARD ASSESSMENT SYSTEM AND METHOD

(71) Applicant: U.S.A. as represented by the Administrator of the National Aeronautics and Space Administration, Washington, DC (US)

(72) Inventors: DALIA KIRSCHBAUM, Bethesda, MD (US); THOMAS A. STANLEY, College Park, MD (US); PATRICE CAPPELAERE, Ellicott City, MD (US)

(21) Appl. No.: 15/236,525

(22) Filed: Aug. 15, 2016

(51) Int. Cl. G01W 1/06; G01C 21/00; G08B 21/10; G01W 1/14

(52) U.S. Cl. CPC G01W 1/06; G01W 1/14; G01C 21/005; G08B 21/10; G06T 11/60

(57) ABSTRACT

The present invention relates to a computer-implemented method of providing a landslide hazard assessment, including: inputting a region from which to retrieve geographic information from a database or from a user in real-time, using an input device of a computer system; retrieving geographic information from the database, on the region; retrieving satellite-based remote sensing data from the external database in real-time or near real-time from the region, the external database being accessed by the computer system over the internet; creating a susceptibility map which is divided into a plurality of categories that represent relative susceptibility to landslides; showing the plurality of categories on the susceptibility map on a display of the computer system, using a defining characteristic; comparing a current daily rainfall accumulation from the external database to a daily rainfall threshold; and issuing a moderate- or high-hazard level landslide nowcast, depending on a result of the comparison.

### BACKGROUND OF THE INVENTION

### 1. Field of the Invention

The present invention relates to a computer program and system capable of utilizing globally available satellite products for landslide hazard assessment. The present invention also provides a flexible framework to interchange the individual program components and adjust thresholds based on access to new data and calibration sources. In one embodiment, the program assigns thresholds to susceptibility, daily rainfall and antecedent rainfall, and based on the situation at a given pixel, issues on a predetermined basis—such as daily—either a high hazard, a moderate hazard or a null nowcast, of a predicted landslide.

### 2. Description of the Related Art

Landslides pose a serious threat to life and property in many regions of the world. The ability to estimate or forecast landslide activity is largely dependent on the scale at which the analysis is undertaken as well as the availability of geomorphologic, atmospheric and landslide data for the study region. Physically based models focusing on the local hillslope scale require a broad range of geotechnical and hydro-mechanical in situ variables for accurate modeling of individual slope failures. Empirical studies can focus on local to regional scales but are constrained by the availability of landslide information and surface products that can be used to create a homogenous picture of landslide hazard over the region.

The timing of rainfall-triggered landslides is challenging to predict due to the scarcity of real-time precipitation measurements, in situ landslide inventories, and information about local ground conditions. Satellite rainfall products provide the opportunity to approximate the conditions that lead to rainfall-triggered landslides over regional scales, especially where rain gauge networks are sparse. The Tropical Rainfall Measuring Mission (TRMM) and its successor, the Global Precipitation Measurement (GPM) mission, provide a multi-decadal record of precipitation estimates that can be used to systematically evaluate rainfall and estimate landslide triggering relationships over multiple spatial and temporal scales.

Previous work has used rainfall intensity-duration (I-D) thresholds to estimate the landslide hazard over time at a variety of spatial scales. Landslide susceptibility zonation studies have examined the components of landslide hazard using a range of heuristic and statistical models at diverse spatial scales. Existing work has also combined both rainfall accumulation thresholds and susceptibility information to provide early warning for landslides at a sub-national level. Previous work has resulted in a dynamic landslide model at the regional scale for four countries in Central America: Honduras, Nicaragua, El Salvador and Guatemala. This existing model applied a single I-D threshold to TRMM Multi-satellite Precipitation Analysis precipitation data and a susceptibility map to produce landslide nowcasts.

A regional, real-time landslide hazard assessment is exceptionally challenging due to the limited availability of in situ data on landslides, rainfall gauges (particularly in developing countries), and consistent surface variables like topography. Previous models had considered components of landslide hazard, either susceptibility, rainfall intensity duration over local, regional or even global scales. However, there have been few attempts to connect these two variables to give a near real-time estimate of potential landslide hazard areas at a regional scale.

With the advent of new landslide catalogs, and remote sensing which can provide increased information to better identify landslide hazards at larger scales due to its global coverage and near real-time sampling frequency, it is would be advantageous to explore capabilities to increase situational awareness to landslides across a particular region.

### SUMMARY OF THE INVENTION

The present invention relates to a computer program and system which allows regionally coordinated situational awareness with respect to landslides. The present invention offers a new flexible framework for evaluating potential landslide activity in near real time. In one embodiment, the present invention provides a landslide framework with the capability to utilize globally available satellite products for regional landslide hazard assessment. The present invention also provides a flexible framework to interchange the individual model components and adjust thresholds based on access to new data and calibration sources. In one embodiment, the present invention assigns thresholds to susceptibility, daily rainfall and antecedent rainfall, and based on the situation at a given pixel, issues on a predetermined basis—such as daily—either a high hazard, a moderate hazard or a null nowcast, of a predicted landslide.

The program of the present invention estimates potential landslide activity across broad regions. While intense rainstorms are the most important trigger of landslides worldwide, landslides are often exacerbated by prior soil moisture conditions. Using antecedent daily rainfall has been shown to help predict landslides, especially those cases where the triggering precipitation event is prolonged but less intense.

In one embodiment, the program of the present invention integrates a regional landslide susceptibility map and satellite-based rainfall on a daily basis, as well as incorporates an antecedent rainfall index (ARI) to represent the conditions prior to the day of the triggering event. Since the relationship between rainfall, antecedent rainfall, susceptibility and landslide triggering is not linear, the program of the present invention employs a novel approach to accurately resolve landslide nowcasts while minimizing the overall number of alerts issued. In one embodiment, the program of the present invention may also incorporate other hydrological or atmospheric variables such as numerical weather forecasts or satellite-based soil moisture estimates, for improved hazard analysis.

In one embodiment, the availability of free satellite-based near real-time rainfall data allows the program of the present invention to be used in any study area with a spatiotemporal record of landslide events, and can be used with different hydro-meteorological and in situ data products.

In one embodiment, using a regionally distributed, percentile-based threshold approach, the program of the present invention outputs a pixel-by-pixel nowcast in near real-time at a resolution of 30 arcseconds to identify areas of moderate and high landslide hazard. In one embodiment, the daily and antecedent rainfall thresholds in the program of the present invention are calibrated using a subset of the Global Landslide Catalog (GLC) available for the time period.

In one exemplary embodiment, the program of the present invention incorporates a new landslide susceptibility map developed for Central America and the Caribbean region with local percentile-based rainfall and antecedent rainfall thresholds. The program of the present invention will allow a user to view a daily map identifying moderate and high landslide hazard areas, static landslide susceptibility, precipitation and antecedent rainfall over the study domain, and download the program's major data inputs.

In one embodiment, a computer-implemented method of providing a landslide hazard assessment, includes: inputting a region from which to retrieve geographic information from at least one database or from a user in real-time, using an input device of a computer system; retrieving geographic information from the at least one database on the region; retrieving satellite-based remote sensing data from at least one external database in real-time or near real-time from the region, the at least one external database being accessed by the computer system over the internet; creating a susceptibility map which is divided into a plurality of categories that represent relative susceptibility to landslides; and showing the plurality of categories on the susceptibility map on a display of the computer system, using a defining characteristic.

In one embodiment, the method further includes: combining a faults regional geographic dataset, with global slope, soils, and roads geographic datasets from the at least one database or the at least one external database, with the geographic information and the satellite-based remote sensing data; and overlaying the datasets onto a geographical platform to create the susceptibility map.

In one embodiment, the resolution of the susceptibility map is 30 arcseconds.

In one embodiment, antecedent rainfall data is included in the satellite-based remote sensing data, and the antecedent rainfall data is collected on a continuous basis from the at least one external database in near real-time.

In one embodiment, rainfall data is retrieved from modeled precipitation databases.

In one embodiment, rain gauge or forecasted rainfall data from the region is included in the satellite-based remote sensing data, and is accessed in real-time from the at least one external database.

In one embodiment, the method further includes: comparing a current daily rainfall accumulation from the at least one external database to a daily rainfall threshold; and issuing a moderate- or high-hazard level landslide nowcast or a landslide forecast, depending on a result of the comparison.

In one embodiment, each 0.25° pixel of the pixels on the susceptibility map shown on the display, is assigned a separate daily rainfall threshold.

In one embodiment, the method further includes: creating a susceptibility index to quantify the relative susceptibility to landslides; and excluding from the plurality of categories of the pixels shown on the susceptibility map, pixels with a susceptibility index of 1 or 0.

In one embodiment, the method further includes: creating an antecedent rainfall index; and comparing the antecedent rainfall index for each pixel that has a susceptibility index of 2 and above, to a 50^{th} percentile value.

In one embodiment, the method further includes: comparing, on condition that the antecedent rainfall index meets or exceeds said 50^{th} percentile, a current daily rainfall to the daily rainfall threshold.

In one embodiment, on condition that the current daily rainfall meets or exceeds said 50^{th} percentile, a moderate-hazard level landslide nowcast is issued.

In one embodiment, on condition that the current daily rainfall meets or exceeds a 95^{th} percentile, a high-hazard level landslide nowcast is issued.

In one embodiment, on condition that the current daily rainfall does not meet said 50^{th} percentile, a null event is issued.

In one embodiment, the method further includes: comparing, on condition that the antecedent rainfall index does not meet the 50^{th} percentile, a current daily rainfall to the daily rainfall threshold.

In one embodiment, on condition that the current daily rainfall meets or exceeds a 90^{th} percentile, a moderate-hazard level landslide nowcast is issued.

In one embodiment, on condition that the current daily rainfall meets or exceeds a 95% percentile, a high-hazard level landslide nowcast is issued.

In one embodiment, on condition that the current daily rainfall does not meet the 90^{th} percentile, a null event is issued.

In one embodiment, the method further includes: issuing an alert by electronic means, of said moderate- and high-hazard level landslide nowcasts.

A computer system which provides a landslide hazard assessment, including: at least one processor executing program code, the program code including the steps of: inputting a region from which to retrieve geographic information from at least one database or from a user in real-time, using an input device of a computer system; retrieving geographic information from the at least one database on the region; retrieving satellite-based remote sensing data from at least one external database in real-time or near real-time from the region, the at least one external database being accessed by the computer system over the internet; creating a susceptibility map which is divided into a plurality of categories that represent relative susceptibility to landslides; and showing the plurality of categories on the susceptibility map on a display of the computer system, using a defining characteristic.

In one embodiment, a non-transitory computer-accessible medium having a program which contains executable instructions, the program comprising the steps of: inputting a region from which to retrieve geographic information from at least one database or from a user in real-time, using an input device of a computer system; retrieving geographic information from the at least one database on the region; retrieving satellite-based remote sensing data from at least one external database in real-time or near real-time from the region, the at least one external database being accessed by the computer system over the internet; creating a susceptibility map which is divided into a plurality of categories that represent relative susceptibility to landslides; and showing the plurality of categories on the susceptibility map on a display of the computer system, using a defining characteristic.

Thus has been outlined, some features consistent with the present invention in order that the detailed description thereof that follows may be better understood, and in order that the present contribution to the art may be better appreciated. There are, of course, additional features consistent with the present invention that will be described below and which will form the subject matter of the claims appended hereto.

In this respect, before explaining at least one embodiment consistent with the present invention in detail, it is to be understood that the invention is not limited in its application to the details of construction and to the arrangements of the components set forth in the following description or illustrated in the drawings. Methods and apparatuses consistent with the present invention are capable of other embodiments and of being practiced and carried out in various ways. Also, it is to be understood that the phraseology and terminology employed herein, as well as the abstract included below, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the methods and apparatuses consistent with the present invention.

### BRIEF DESCRIPTION OF THE DRAWINGS

FIG. 1 is a schematic diagram of a computing system according to one embodiment consistent with the present invention.

FIG. 2 is a flow chart which provides the main steps of the program, according to one embodiment consistent with the present invention.

FIG. 3 is a map showing landslide hazard assessment by pixellation on a computer screen, according to one embodiment consistent with the present invention.

### DESCRIPTION OF THE INVENTION

The present invention relates to a computer program and system which allows regionally coordinated situational awareness with respect to landslides. The program of the present invention provides a new flexible framework for evaluating potential landslide activity in near real time.

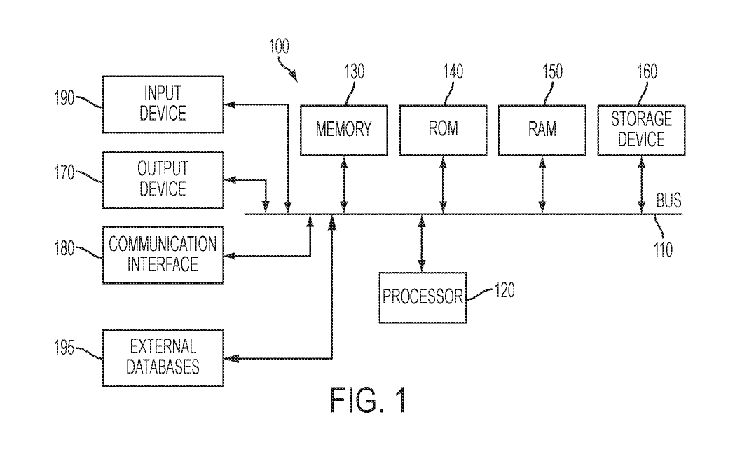

With reference to FIG. 1, an exemplary system includes a general-purpose computing device 100, including a processing unit (CPU) 120 and a system bus 110 that couples various system components including the system memory, such as read-only memory (ROM) 140 and random access memory (RAM) 150 to the processing unit 120. Other system memory 130 may be available for use as well. It can be appreciated that the invention may operate on a computing device with more than one CPU 120 or on a group or cluster of computing devices networked together to provide greater processing capability. A processing unit 120 can include a general purpose CPU controlled by software as well as a special-purpose processor. The processing unit 120 is controlled by software. Particular functionality may also be built into the design of a separate computer chip. Of course, a processing unit includes any general purpose CPU and a module configured to control the CPU as well as a special-purpose processor where software is effectively incorporated into the actual processor design. A processing unit may essentially be a completely self-contained computing system, containing multiple cores or CPUs, a bus, memory controller, cache, etc. A multi-core processing unit may be symmetric or asymmetric.

The system bus 110 may be any of several types of bus structures including a memory bus or memory controller, a peripheral bus, and a local bus using any of a variety of bus architectures. A basic input/output (BIOS) stored in ROM 140 or the like, may provide the basic routine that helps to transfer information between elements within the computing device 100, such as during start-up. The computing device 100 further includes storage devices 160 such as a hard disk drive, a magnetic disk drive, an optical disk drive, tape drive or the like. The storage device 160 is connected to the system bus 110 by a drive interface. The drives and the associated computer readable media provide nonvolatile storage of computer readable instructions, data structures, program modules and other data for the computing device 100. In one aspect, a hardware module that performs a particular function includes the software component stored in a tangible computer-readable medium in connection with the necessary hardware components, such as the CPU, bus, display, and so forth, to carry out the function. The basic components are known to those of skill in the art and appropriate variations are contemplated depending on the type of device, such as whether the device is a small, handheld computing device, a desktop computer, or a computer server.

Although the exemplary environment described herein may employ a hard disk, it should be appreciated by those skilled in the art that other types of computer-readable media which can store data that are accessible by a computer, such as magnetic cassettes, flash memory cards, digital versatile disks, cartridges, random access memories (RAMs), read only memory (ROM), a cable or wireless signal containing a bit stream and the like, may also be used in the exemplary operating environment.

To enable user interaction with the computing device 100, an input device 190 represents any number of input mechanisms, such as a microphone for speech, a touch-sensitive screen for gesture or graphical input, keyboard, mouse, motion input, speech and so forth. The input may be used by the presenter to indicate the beginning of a speech search query. The device output 170 can also be one or more of a number of output mechanisms known to those of skill in the art. In some instances, multimodal systems enable a user to provide multiple types of input to communicate with the computing device 100. The communications interface 180 generally governs and manages the user input and system output. There is no restriction on the invention operating on any particular hardware arrangement and therefore the basic features here may easily be substituted for improved hardware or firmware arrangements as they are developed.

For clarity of explanation, the illustrative system embodiment is presented as comprising individual functional blocks (including functional blocks labeled as a “processor”). The functions these blocks represent may be provided through the use of either shared or dedicated hardware, including, but not limited to, hardware capable of executing software and hardware, such as a processor, that is purpose-built to operate as an equivalent to software executing on a general purpose processor. For example the functions of one or more processors presented in FIG. 1 may be provided by a single shared processor or multiple processors. (Use of the term “processor” should not be construed to refer exclusively to hardware capable of executing software.) Illustrative embodiments may comprise microprocessor and/or digital signal processor (DSP) hardware, read-only memory (ROM) for storing software performing the operations discussed below, and random access memory (RAM) for storing results. Very large scale integration (VLSI) hardware embodiments, as well as custom VLSI circuitry in combination with a general purpose DSP circuit, may also be provided.

The logical operations of the various embodiments are implemented as: (1) a sequence of computer implemented steps, operations, or procedures running on a programmable circuit within a general use computer, (2) a sequence of computer implemented steps, operations, or procedures running on a specific-use programmable circuit; and/or (3) interconnected machine modules or program engines within the programmable circuits.

According to one embodiment, the present invention may be implemented using software applications that reside in a client and/or server environment. According to another embodiment, the present invention may be implemented using software applications that reside in a distributed system over a computerized network and across a number of client computer systems. Thus, in the present invention, a particular operation may be performed either at the client computer, the server, or both. While the system of the present invention may be described as performing certain functions, one of ordinary skill in the art will readily understand that the program may perform the function rather than the entity of the system itself. According to one embodiment of the invention, the program that runs the system 100 may include separate programs having code that performs desired operations. According to one embodiment, the program that runs the system 100 may include a plurality of modules that perform sub-operations of an operation, or may be part of a single module of a larger program that provides the operation. Further, although the above-described features and processing operations may be realized by dedicated hardware, or may be realized as programs having code instructions that are executed on data processing units, it is further possible that parts of the above sequence of operations may be carried out in hardware, whereas other of the above processing operations may be carried out using software.

According to one embodiment of the invention, the server may include a single unit or may include a distributed system having a plurality of servers or data processing units. The server(s) may be shared by multiple users in direct or indirect connection to each other. The server(s) may be coupled to a communication link that is preferably adapted to communicate with a plurality of client computers. Although the above physical architecture has been described as client-side or server-side components, one of ordinary skill in the art will appreciate that the components of the physical architecture may be located in either client or server, or in a distributed environment.

The underlying technology allows for replication to various other sites. Each new site may maintain communication with its neighbors so that in the event of a catastrophic failure, one or more servers may continue to keep the applications running, and allow the system to load-balance the application geographically as required.

Embodiments within the scope of the present invention may also include computer-readable media for carrying or having computer-executable instructions or data structures stored thereon. Such computer-readable media can be any available media that can be accessed by a general purpose or special purpose computer, including the functional design of any special purpose processor as discussed above. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions, data structures, or processor chip design. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, objects, components, data structures, and the functions inherent in the design of special-purpose processors, etc., that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Those of skill in the art will appreciate that other embodiments of the invention may be practiced in network computing environments with many types of computer system configurations, including personal computers, hand-held devices, multi-processor systems, microprocessor-based or programmable consumer electronics, network PCs, minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

In one embodiment, the computer program and system of the present invention provides a novel framework with the capability to access and utilize globally available satellite products for regional landslide hazard assessment. The computer program of the present invention is designed to be flexible in order to interchange the individual components and to adjust thresholds based on access to new data and calibration sources. In one embodiment, the program assigns thresholds to inputs on landslide susceptibility, daily rainfall and antecedent rainfall, and based on the situation at a given pixel, the program issues, on a predetermined basis—i.e., daily—either a high hazard, a moderate hazard or a null nowcast, of a predicted landslide.

In one embodiment, the program of the present invention creates a novel daily map of a given region at a website, the map which allows a user to view and identify program-predicted moderate and high landslide hazard areas, static landslide susceptibility, precipitation, and antecedent rainfall, over the given region. Further, the user may download the program's major data inputs from external databases, which are stored in storage device 160, for their records.

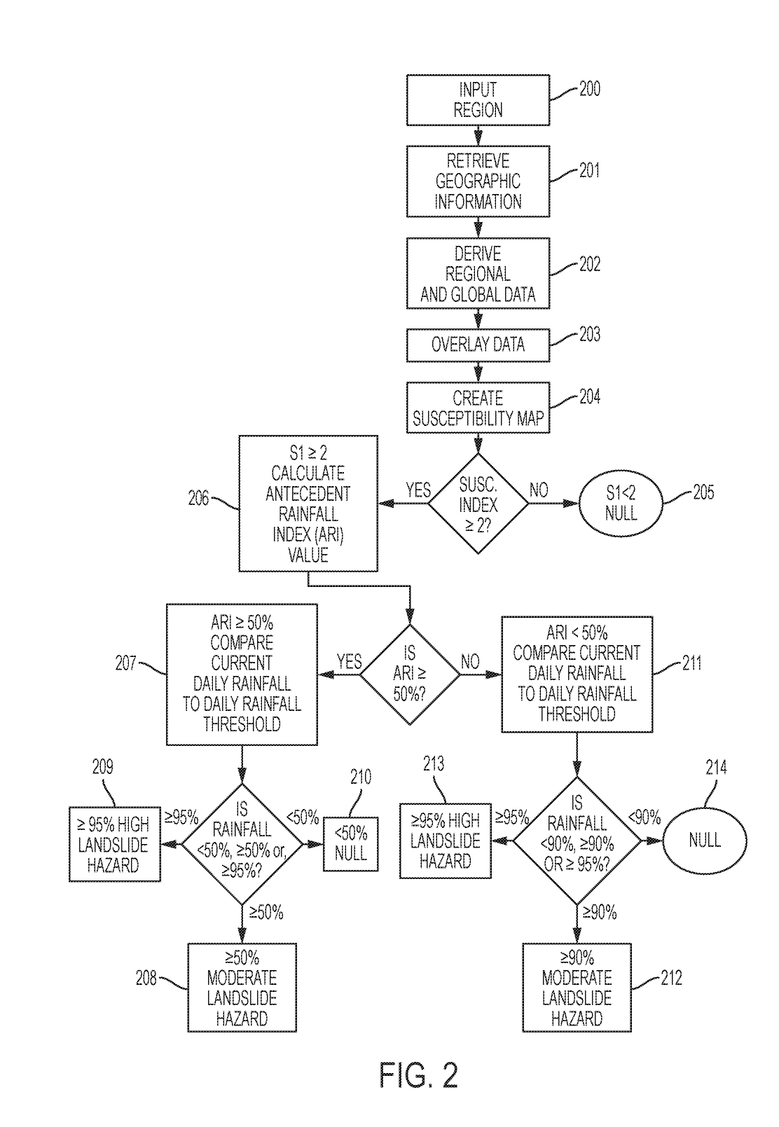

In one embodiment, the program of the present invention is accessed on a website by an authorized user, who inputs a desired region from which to obtain predictive information on potential landslide activity (see FIG. 2) in step 200. The program is designed to retrieve geographic information already stored in storage device 160, or retrieve geographic information from external databases 195, or receive inputs via input device 190 in real-time (step 201). The information retrieved from external databases 195 includes satellite-based remote sensing data. The data retrieved from the external databases may be in real-time, near real-time, or from stored information.

In one embodiment, upon identification of the desired region, the program creates a susceptibility map of the region for the user (see steps 202-204). The susceptibility map is created by the program at a resolution of 30 arcseconds, and the susceptibility map is used to discriminate between susceptible and non-susceptible regions for landslides.

To achieve a consistent output across a given region, one “regional” (faults) and three “global” (slope, soils and roads) geographic datasets are combined by the program, in step 202, from information retrieved from the databases (i.e., external databases 195 or storage device 160).

In one embodiment, the program derives the slope data from the 3 arc seconds Shuttle Radar Topography Mission (SRTM) database, and the dataset is the 70^{th} percentile slope (about 1 km), as retrieved from the U.S. Geological Survey (USGS), for example. Elevation can be obtained by the program, for example, from Digital Elevation Models from Digital Globe or Worldview-1, 2, or ASTER, which have about a 2-15 meter resolution.

In one embodiment, the soils dataset is obtained, for example, by the program from the global Harmonized World Soil Database, and is provided in a resolution of 30 arcseconds, with a nominal scale of 1:5 000 000. The Soil Moisture Active Passive data (SMAP; http://nasa.gov/smap) or modeled soil moisture products within this area of complex terrain and dense tropical vegetation, may also be used.

For example, the SMAP provides about a 36 km resolution, and 1-3 day latency presently. With the methods of the present invention, it is possible to determine the relationship between the water content of surficial soils and deeper soils, resulting in an estimate of pore pressure at critical depths below the ground surface. A different approach would be to separate the geologic and topographic properties currently embodied in the susceptibility map, then use them directly in the program.

In one embodiment, other triggering variables such as seismicity may also be included, if desired. In some regions, temperature has been shown to drive landslide triggering during freeze/thaw episodes or spring; however, in certain regions, such as the Central American region, this triggering variable is less relevant given the predominant tropical or subtropical temperatures. The inclusion of other susceptibility or triggering variables within the program's framework may be implemented by the program in step 202.

The roads dataset is obtained from the Global Roads Open Access Data Set, or OpenStreetMap, with an accuracy which ranges from 30-1265 m.

Fault zones are obtained by the program from stored information derived from maps showing geology, oil and gas fields, and geologic provinces of the predetermined region, with a resolution of 1:2 500 000.

In one embodiment, forest loss from the Global Forest Change 2000-2013 dataset, which has a resolution of 30 meters, is obtained by the program. Population can also be included in the susceptibility map by the program, using LandScan, which has a 1 km resolution.

In one embodiment, variables considered not to enhance landslide predictions, such as forest cover and geology, and those that were largely redundant, such as cation exchange capacity, are eliminated and not considered by the program. However, one of ordinary skill in the art would know what datasets to include or consider and which to eliminate.

In one embodiment, the four layers—faults, slope, soils, and roads—are overlaid by the program in step 303, in a geographical platform using fuzzy operators. Fuzzy logic categorizes explanatory variables based on how successfully they fit within a hazard assessment scheme. This heuristic approach is where expert feedback and landslide inventories were used to guide weighting of fuzzy membership functions.

The susceptibility map was then calculated by the program at about a 1 km resolution of binned (high-low) and unbinned values. Specifically, first, each variable is transformed by the program into a “possibility” between zero (representing low landslide hazard) and 1 (representing high hazard), through use of a novel fuzzy membership function. Next, the non-topographic variables are combined by the program with a “fuzzy gamma” function, in which gamma is set to 0.4. Finally, the output was overlaid by the program with the transformed slope values with the novel “fuzzy product” operator—a function chosen to prevent the identification of flat ground as hazardous.

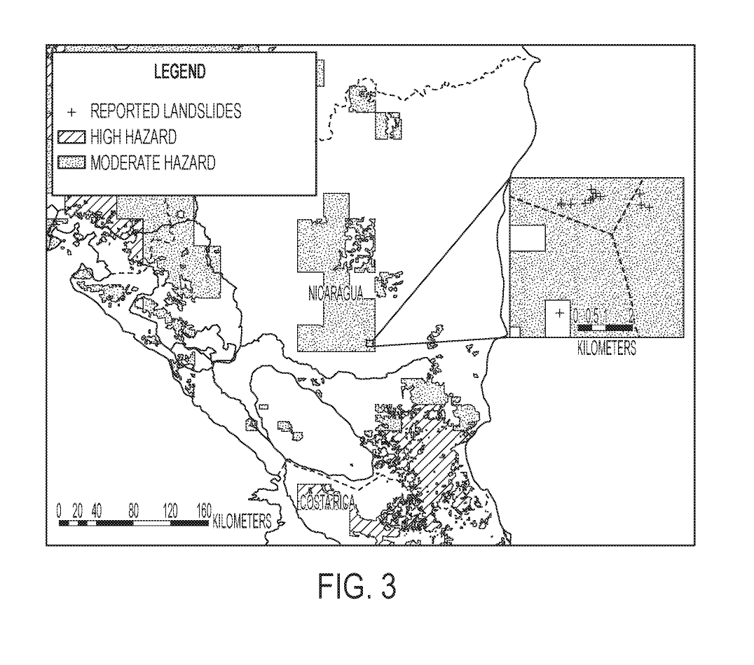

In one embodiment, using the standard deviation classification scheme, the program then divides the susceptibility map into five categories that present relative susceptibility to landslides: very low, low, medium high, and very high. These categories are shown on the map by the program in step 204, using color or other defining characteristics, and presented to the user on the computer screen (see FIG. 3, for example—although FIG. 3 shows a final map).

Once the susceptibility map is created in step 204, and the categories of susceptibility have been determined, those pixels that are deduced by the program to have “very low” susceptibility to landslides (susceptibility index (SI) of 1 or 0), are excluded by the program from further analysis (null), in step 205. The program then considers all other pixels as having a non-negligible chance of slope failure.

Next, for those pixels that have an SI of 2 and above, the program compares the antecedent rainfall index (ARI) value for each pixel in step 206, to the 50^{th} percentile value. The antecedent rainfall is a measurement of the amount of precipitation required to trigger landslides, and is usually dependent upon the volume of prior rain and the permeability of the soils and rocks. The program uses remotely sensed rainfall as a proxy for soil moisture, since time is required for rain to infiltrate soil and rock and generate higher pore pressures that lead to slope instabilities as well as for pore pressure to dissipate. This remotely sensed data is collected in by the program on a continuous basis from external databases 195 in near real-time.

The antecedent rainfall index (ARI) value is determined by the program according to the following equation, which was created from the Tropical Rainfall Measuring Mission (TRMM) Multi-Satellite Precipitation Analysis Real-Time (TMPA-RT) daily rainfall estimates using a time-weighted average of the previous 60 days:

Σₜ₌₁⁶⁰wt·pt/Σₜ₌₁⁶⁰wt (1)
where t=the number of days before the present, Pₜ=the precipitation at time t and wₜ=t^{-0.5}. The 60-day window was chosen by calibrating the program using landslide reports and 500 randomly selected locations.

Satellite precipitation estimates from the TRMM TMPA-RT database are available at a resolution of 0.25°×0.25°, and provides a snapshot of precipitation rates using TRMM and other satellites to provide a precipitation map every 3 hours, with a 12 hour latency, from 50° N-S. TMPA-RT data are available from March 2000-present and are accessed by the program in near real-time, from the relevant external database 195.

In one embodiment, modeled precipitation databases, such as the GEOS-5 Model (NASA) may be accessed by the program to provide 24, 48, and 72 hour precipitation forecasts (updated every 6 hours), with a 0.3125° longitude×0.25° latitude resolution. Note that rainfall data are made available without cost by NASA for every location between 50° N to 50° S latitude.

Further, in one embodiment, the Integrated Multi-Satellite Retrievals for Global Participation Measurement (GPM's IMERG) data may also be incorporated into the system by accessing the external database 195 in near real-time, to extend the latitudinal boundaries of the precipitation information to 65° N-S and increase the spatiotemporal resolution to 30 min sampling at a 0.1° spatial resolution, every 30 minutes, with a 5 hour latency, to provide a consistent precipitation dataset. If rain gauge or forecasted rainfall data are available for a region, this data may be accessed in real-time or near real-time and may also be applied by the program to create a more accurate real-time hazard assessment system.

Thus, the program of the present invention combines thresholds for current and antecedent rainfall in such a way as to differentiate landslide and non-landslide rainfall events, since higher soil moisture values prior to a landslide occurrence is one factor in future landslide triggering.

Next, the program compares the current daily rainfall accumulation to the daily rainfall threshold, and a moderate or high landslide nowcast is issued by the program. In one embodiment, the program may be used to provide landslide forecasts, rather than near real-time nowcasts based upon precipitation forecast data, rather than recent precipitation.

An additional capability of the present invention is the ability to access, share, edit and accept volunteered geographic information on landslide events in multiple languages.

In one embodiment, the program utilizes a statistical distribution of daily rainfall over a 13-year record, using percentiles to create a precipitation metric that could be compared across morphologies and landslide events. A daily precipitation time series can be prepared by the program over a predetermined time period over the predetermined region, with no rainfall days removed from the calculation. Then, every fifth percentile is calculated by the program from the distribution of non-zero values using the “quantile” function's default method. The resulting series of raster files identify the local precipitation distribution at each pixel and provide a more localized way to address regional landslide triggering. The rainfall thresholds are then calibrated by the program with the retrieved landslide data from the Global Landslide Catalog (GLC) to assign a separate rainfall threshold for each 0.25° pixel.

In performing the comparison between the current daily rainfall accumulation and the daily rainfall threshold, if the program determines that the 50^{th} percentile rainfall is met or exceeded in step 207, and the soils are considered to be wet (antecedent rainfall index (ARI)>50^{th} percentile), a moderate-hazard level is assigned by the program in step 208.

If the rainfall exceeds the 95^{th} percentile, a high hazard is assigned by the program in step 209. Note that the high-hazard nowcast provides a representation of extreme rainfall at any time over the given region, and the 95^{th} percentile is based on qualitative analysis of the rainfall distributions over the given area.

If the rainfall is less than the 50^{th} percentile, then there is no landslide event predicted, and the program results in null for those conditions (step 210).

In dry conditions (ARI<50^{th} percentile), the program compares the current daily rainfall to the daily rainfall threshold in step 211, and assigns a moderate-hazard level if the daily rainfall meets or exceeds the 90^{th} percentile (step 212), and a high-hazard nowcast is generated if rainfall meets or exceeds the 95^{th} percentile (step 213). Anything less than the 90^{th} percentile results in a null (step 214).

Note that the “high-hazard” nowcast issued by the program under normally dry conditions, is designed to represent the extreme triggering conditions under which landslides have a higher probability of occurrence, whereas the “moderate-hazard” nowcasts represent a lower probability of landslide activity.

Varying alert signals may be sent by the program based on user requirements and the severity of the landslide prediction (i.e., moderate vs. high hazard). Normally, alerts are forwarded by electronic means, such as email, text, etc.

Although these percentiles have been chosen by the program to represent various predictive categories, one of ordinary skill in the art would know that the program may be used to more narrowly define each of the hazard classes, depending on the user's requirements.

Accordingly, the program of the present invention enables end users to observe landslide hazards in near real-time and provides context for them to look more closely into landslide hotspot areas. The program of the present invention successfully resolves the potential conditions for landslides with a mix of soil, rock and other debris, ranging from moderate to shallow depths and occurring at moderate to high velocities (excluding other triggering variables such as earthquake occurrence, and anthropogenic triggers (mining, construction, etc.) etc. The program of the present invention provides a unique way to visualize hazard areas while also taking account of other components (i.e., TRMM, landslides, etc.), and where users can adapt these components and thresholds to better fit their region and purposes. The flexibility of the program of the present invention represents an advancement to enable end users to adapt the program for more effective situational awareness.

In exemplary testing to determine whether the program accurately predicted past landslides, the regions of Central America and Hispaniola were reviewed for past landslide activity as compared to the program's predictive capabilities. In the exemplary embodiment, the Central American study area ranged from 93 to 76° W longitude and from 6 to 19° N latitude. In addition to the nations of Central America, the analysis included Jamaica and small portions of Mexico and Colombia. The Hispaniolan study area encompassed Haiti, the Dominican Republic and Puerto Rico.

Central America and the Hispaniolan region have tropical climates that make them vulnerable to landslide activity, and all of the countries in the studied region had experienced significant losses from landslides as a result of previous natural disasters such as Hurricane Mitch in 1998 and the 2010 Haiti earthquake, among others. These regions are also very likely to suffer significant losses from landslides as a result of changing precipitation and tropical cyclone patterns in a changing climate.

In order to enhance the accuracy of the susceptibility map, since the data retrieved from the databases 160, 195 by the program, may or may not be complete, or accurate in temporal or spatial scale, the program utilizes a plurality of historical landslide catalogs—varying greatly in temporal and spatial scale, size and completeness—to evaluate, and calibrate, the susceptibility map for accuracy. Several different landslide catalogs or inventories are available within Central America that have varying geographic extents, compilation methodologies, temporal information and accuracies, which were drawn upon by the program. While each of these inventories was useful to compute the regional static susceptibility map, the Global Landslide Catalog (GLC), which provides event-based landslides, included the most relevant spatial and temporal information for calibrating and evaluating the program of the present invention, and was used to compare against the results of the susceptibility map for a given area. The combined landslide data covered the years 2007-2013.

For any spatiotemporal uncertainties with the GLC, landslide points were spatially and temporally buffered, by predetermined (i.e., 1, 3, and 7 day) windows around the date, or by 1 or 5 km circular buffers, and a variable buffer based on spatial accuracy, around the location.

In the exemplary embodiment, the results of the comparison showed that when spatial and temporal tolerances are included due to the built-in inaccuracies in the landslide catalogs or inventories, the true positive rate (TPR) or predictive success of estimating landslides and a moderate-hazard nowcast, was in the range 63-91% for Central America and 57-81% for Hispaniola (see Table 1). The lower overall range for Hispaniola was explained by the limited accuracy and depth of information in the Hispaniolan landslide catalogs.

In contrast, the false positive rate (FPR) was only 1% for high-hazard nowcasts and 7-11% for moderate-hazard nowcasts. From the Central America and Hispaniolan studies, it was shown that a tolerance within 1 day and 1 km of reported landslides placed the TPR of the Central American catalog at 79% and the Hispaniolan catalog at 71%.

These results proved that the present invention has good to excellent performance in predicting landslide activity despite the many variables and physical parameters that defy human assessment.

TABLE 1

| | Spatial | | | | |
|---|---|---|---|---|---|
| | Buffer | 1-day | 3-day | 7-day | Susceptible |
| | distance | window | window | window | pixels |
| Central | 0 km | 64 (26) | 77 (37) | 83 (47) | 90 |
| America | 1 km | 67 (28) | 81 (39) | 87 (50) | 92 |
| 2007-2013 | 5 km | 72 (34) | 85 (48) | 93 (59) | 100 |
| | Variable | 81 (40) | 89 (57) | 94 (65) | 100 |
| Hispaniola | 0 km | 21 (17) | 29 (21) | 46 (21) | 50 |
| 2007-2013 | 1 km | 33 (21) | 67 (29) | 67 (29) | 75 |
| | 5 km | 46 (21) | 71 (46) | 88 (50) | 100 |
| | Variable | 54 (21) | 71 (50) | 88 (54) | 96 |
| Central | 0 km | 58 (12) | 74 (33) | 79 (47) | 86 |
| America | 1 km | 63 (12) | 79 (35) | 84 (49) | 93 |
| 2014 | 5 km | 72 (14) | 86 (44) | 91 (56) | 100 |
| | Variable | 67 (12) | 84 (37) | 91 (51) | 91 |
| Hispaniola | 0 km | 43 (43) | 57 (43) | 71 (71) | 86 |
| 2014 | 1 km | 57 (43) | 71 (43) | 86 (71) | 100 |
| | 5 km | 71 (43) | 86 (43) | 86 (71) | 100 |
| | Variable | 71 (43) | 86 (43) | 86 (71) | 100 |

FIG. 3 shows the landslide hazard potential for 23 Jun. 2014 on a final susceptibility map. Black crosses indicate locations where a cluster of landslides occurred near El Ayote, Nicaragua. Yellow pixels (moderate hazard) and red pixels (high hazard) are shown for that day. Of 14 landslides, 13 were predicted by the program in the moderate-hazard category. The southern-most landslide was located in a relatively flat location that had been mapped by the program as having “very low” landslide susceptibility, so it was not predicted despite daily rainfall exceeding the 50th percentile threshold.

Accordingly, the present invention provides a unique system to estimate potential landslide activity over a very broad area in near real-time using input data that have very few points (relative to the area being considered) and even with variable accuracy. The present invention serves as a situational awareness tool that flags potentially affected areas for further investigation, and may be used as a direct tool for issuing warnings or declaring impacts. Results of the comparison of the program's predictive capabilities with past landslide activity, showed that expanded search criteria, or spatial buffers and temporal windows added to the landslide information retrieved from geographic datasets, increase the true positive rate (TPR) of predicting landslides (see step 201).

Although the high-hazard model has a relatively low probability of predicting landslides due to the fact that many landslide reports in the GLC are not recorded on the same day as extreme rainfall events, given the limitations of the data available for evaluating the program as well as for calibration of its components, the results obtained encourage the program's use as a regional situational awareness tool for potential landslide activity.

The novel program of the present invention is currently implemented in one embodiment, in a multi-hazard website, servicing Central America and Hispaniola. While the program is currently parameterized for this region, one of ordinary skill in the art would know that the program may be adapted to serve other landslide-prone locations. This flexible framework of the present program enables different forcing variables (i.e., precipitation, antecedent precipitation) and susceptibility variables to be considered dynamically.

It should be emphasized that the above-described embodiments of the invention are merely possible examples of implementations set forth for a clear understanding of the principles of the invention. Variations and modifications may be made to the above-described embodiments of the invention without departing from the spirit and principles of the invention. All such modifications and variations are intended to be included herein within the scope of the invention and protected by the following claims.

What is claimed is:

1. A computer-implemented method of providing a landslide hazard assessment, comprising:
inputting a region from which to retrieve geographic information from at least one database or from a user in real-time, using an input device of a computer system;
retrieving geographic information from said at least one database on said region;
retrieving satellite-based remote sensing data from at least one external database in real-time or near real-time from said region, said at least one external database being accessed by said computer system over the internet;
creating a susceptibility map which is divided into a plurality of categories that represent relative susceptibility to landslides; and
showing said plurality of categories on said susceptibility map on a display of said computer system, using a defining characteristic.

2. The method according to claim 1, further comprising:
combining a faults regional geographic dataset, with global slope, soils, and roads geographic datasets from said at least one database or said at least one external database, with said geographic information and said satellite-based remote sensing data; and
overlaying said datasets onto a geographical platform to create said susceptibility map.

3. The method according to claim 2, wherein a resolution of said susceptibility map is 30 arcseconds.

4. The method according to claim 2, wherein antecedent rainfall data is included in said satellite-based remote sensing data, and said antecedent rainfall data is collected on a continuous basis from said at least one external database in near real-time.

5. The method according to claim 4, wherein rainfall data is retrieved from modeled precipitation databases.

6. The method according to claim 4, wherein rain gauge or forecasted rainfall data from said region is included in said satellite-based remote sensing data, and is accessed in real-time from said at least one external database.

7. The method according to claim 4, further comprising:
comparing a current daily rainfall accumulation from said at least one external database to a daily rainfall threshold; and
issuing a moderate- or high-hazard level landslide nowcast or a landslide forecast, depending on a result of said comparison.

8. The method according to claim 7, wherein each 0.25° pixel of said pixels on said susceptibility map shown on said display, is assigned a separate daily rainfall threshold.

9. The method according to claim 8, further comprising:
creating a susceptibility index to quantify said relative susceptibility to landslides; and
excluding from said plurality of categories of said pixels shown on said susceptibility map, pixels with a susceptibility index of 1 or 0.

10. The method according to claim 9, further comprising:
creating an antecedent rainfall index; and
comparing said antecedent rainfall index for each pixel that has a susceptibility index of 2 and above, to a 50^{th} percentile value.

11. The method according to claim 10, further comprising:
comparing, on condition that said antecedent rainfall index meets or exceeds said 50^{th} percentile, a current daily rainfall to said daily rainfall threshold.

12. The method according to claim 11, wherein on condition that said current daily rainfall meets or exceeds said 50^{th} percentile, then issuing a moderate-hazard level landslide nowcast.

13. The method according to claim 12, wherein on condition that said current daily rainfall meets or exceeds a 95^{th} percentile, then issuing a high-hazard level landslide nowcast.

14. The method according to claim 11, wherein on condition that said current daily rainfall does not meet said 50^{th} percentile, then issuing a null event.

15. The method according to claim 10, further comprising:
comparing, on condition that said antecedent rainfall index does not meet said 50^{th} percentile, a current daily rainfall to said daily rainfall threshold.

16. The method according to claim 15, wherein on condition that said current daily rainfall meets or exceeds a 90^{th} percentile, then issuing a moderate-hazard level landslide nowcast.

17. The method according to claim 16, wherein on condition that said current daily rainfall meets or exceeds a 95% percentile, then issuing a high-hazard level landslide nowcast.

18. The method according to claim 15, wherein on condition that said current daily rainfall does not meet said 90^{th} percentile, then issuing a null event.

19. The method according to claim 7, further comprising:
issuing an alert by electronic means, of said moderate- and high-hazard level landslide nowcasts.

20. A computer system which provides a landslide hazard assessment, comprising:
at least one processor executing program code, said program code including the steps of:
inputting a region from which to retrieve geographic information from at least one database or from a user in real-time, using an input device of a computer system;
retrieving geographic information from said at least one database on said region;
retrieving satellite-based remote sensing data from at least one external database in real-time or near real-time from said region, said at least one external database being accessed by said computer system over the internet;
creating a susceptibility map which is divided into a plurality of categories that represent relative susceptibility to landslides; and
showing said plurality of categories on said susceptibility map on a display of said computer system, using a defining characteristic.

21. A non-transitory computer-accessible medium having a program which contains executable instructions, the program comprising the steps of:
inputting a region from which to retrieve geographic information from at least one database or from a user in real-time, using an input device of a computer system;
retrieving geographic information from said at least one database on said region;
retrieving satellite-based remote sensing data from at least one external database in real-time or near real-time from said region, said at least one external database being accessed by said computer system over the internet;
creating a susceptibility map which is divided into a plurality of categories that represent relative susceptibility to landslides; and
showing said plurality of categories on said susceptibility map on a display of said computer system, using a defining characteristic.
